(19) United States
(12) Patent Application Publication
(10) Pub. No.: US 2011/0270820 A1
(43) Pub. Date: Nov. 3, 2011

(54) Dynamic Indexing while Authoring and Computerized Search Methods

(76) Inventor: Sanjiv Agarwal, Kolkata (Calcutta) (IN)

(21) Appl. No.: 13/143,347

(22) PCT Filed: Jan. 16, 2009
(86) PCT No.: PCT/IN09/00046

§ 371 Date: Jul. 6, 2011

(51) Int. Cl. G06F 17/30

(52) U.S. Cl. 707/709; 707/E17.108

(57) ABSTRACT

Disclosed herein is a computer-implemented method of dynamically indexing content at the time of authoring or generating content, comprising: applying an authoring or editing or translating or capturing tool for generating content, associated with an autonomous indexer and sorter application; dynamically parsing, indexing and sorting the content in the background as per a lexicon or attributes; storing the content and the related index in a computer network and updating the index in a search engine manager or master or metadata. The method described further comprising the authoring or editing or translating tool is associated with a spellchecker in the indexer and sorter application, for spellchecking the terms before indexing.

### FIELD OF INVENTION

This invention is related to computerized authoring and indexing of documents, and Internet search engine technology.

### DESCRIPTION OF RELATED ART

As the enormous World Wide Web (www) is constantly growing, the centralized search engines require mammoth infrastructure in terms of processing power for recursive crawling and re-crawling for corpus. For example, it is estimated that centralized search engines e.g. Google indexes over 10 billion web pages for which it needs hundreds of thousand servers, and these are expanding at a fast rate. To tackle some of these problems, distributed computing models are being developed, which basically mimic the same processes of spidering, crawling and indexing, but with a bid to utilize decentralized processing and storage in dispersed servers connected to the World Wide Web. For example, WebRACE is a multi-threaded user-driven Java crawler that retrieves from the Web documents according to XML-encoded user profiles that determine the urgency and relevance of collected information. The system subsequently caches and processes retrieved documents. Processing is guided by pre-defined user queries and consists of keyword-searches, title-extraction, summarizing, classification based on relevance with respect to user-queries, estimation of priority, urgency, etc. The need for scheduled crawling and thus a lag between document upload and searchability remain, apart from other disadvantages mentioned. There is also a problem of dead links due to indexing not taking place in real time, e.g. when a page has been most recently indexed by the search engine but has been subsequently deleted by the publisher.

According to some estimates, less than 20% of the web content is indexed, say there is 100000 terabytes of deep web against only about 200 terabyte of surface web. Google's sitemap protocol, mod_oai and Federated search programs for example are aimed at reducing this gap.

Sitemaps supplement but do not replace the existing crawl-based mechanisms that search engines already use to discover URLs. By submitting Sitemaps to a search engine, a webmaster is only helping that engine's crawlers to do a better job of crawling their site(s). Using this protocol does not guarantee that web pages will be included in search indexes.

Distributed computing for third parties or volunteers crawling and indexing has been contemplated in the prior art. For example, in U.S. Pat. No. 7,305,610 assigned to Google Inc., Distributed crawling of hyperlinked documents is disclosed. Sitemap protocol adopted by major search engines allows web masters to submit sitemaps in required format to site engines, for optimizing access to the unrestricted pages on their sites.

The enterprise based search models such as www.fastsearch.com seek to decentralize search engine crawling and indexing. It has modular architecture combined with APIs for a variety of content types to be retrieved using dedicated connectors. Simple connectors are a file system traverser (monitors directories for new, modified, and deleted documents), a Web crawler (does the same for Web pages), and a database connector (uses Simple Query Language (SQL) to extract structured data and embedded documents). There are also connectors dedicated to specific repositories, such as content management systems, e-mail systems, portal servers, and legacy data. In such models, the need for retrieval based indexing of the content after it was generated, remains.

It is observed that the website owners/content providers increasingly feel the need to reach out to their target audience e.g. by prioritizing findability, yet there remains a disjoint between the contents on WWW and the search engines' ability to search all of it. Semantic search methods like RDF and OWL which include content creation applications wherein authors can post metadata such as Tagging, AB Meta, Microformats etc., will increase the workload of content creators without paying them the commensurate incentive.

Spellcheckers associated with web authoring programs e.g. Dreamweaver of Macromedia are well known in the art. Like search engines, these too have a term index in their dictionary or vocabulary, which is looked up while entering words at the time of authoring documents. Spellcheckers applied in the case of search engine queries, such as the “Did you mean . . . ?” feature on Google, use the search engine lexicon as its dictionary. “ieSpell” of www.iespell.com is a spellchecker for the internet explorer browser, which can be downloaded so as to work faster than server side applications.

In centralized search engines like Google, the web spidering or crawling that involves downloading of web pages is done by several distributed crawlers. There is a URL server that sends lists of URLs to be fetched to the crawlers. The web pages that are fetched are then sent to the store server. The store server then compresses and stores the web pages into a repository. Every web page has an associated ID number called a docID, which is generally assigned whenever a new URL is parsed out of a web page.

### SUMMARY OF THE INVENTION

As per the method disclosed herein, the above steps of spidering or crawling are completely avoided, resulting in huge savings in resources, and other advantages as would be explained. As per the present invention, the above functions are replaced by an indexer and sorter program preferably associated with a spellchecker application in web authoring tool, as explained hereinafter.

As per an embodiment of the present disclosures, there is provided an authoring program preferably with a Spellchecker associated with an Indexer and Sorter, referred hereinafter as SIS application. Indexer in centralized search engines like Google for example reads the repository, un-compresses the documents, and parses them. In the present embodiment, the indexer (associated preferably with a spellchecker in the SIS) works in the background while each document is being created, for parsing the document into words or terms. The spellchecker is already programmed to parse the document e.g. by applying a trie algorithm, utilizing an inbuilt dictionary or vocabulary, which can be synchronized with a search engine lexicon as per an example embodiment. Thus, the associated indexer and sorter application can be programmed to take over just after spellchecker application checks the spelling of each word, to create a forward index of the document, mapping the document to each word in the document, by relating the word id as per the lexicon. While doing so, the indexer may also record the number of times a word occurs in a document, generally called “Hits.” If there is a new word in the document not found in the lexicon, the program can have the provision of the author being able to ‘add’ the same in the dictionary and the same can be updated in the search engine lexicon at the time of publishing. In one embodiment, the indexer also has program capability to include a record of a type of position of the said occurrence, an approximation of font size, and capitalization etc., in the hit. This way, the indexer can generate in the background, a forward index of these hits into a bucket associated with each document.

The sorter in the SIS then processes the forward indexes in the bucket, by mapping words to documents, to generate an inverted index resolving word ids to document ids. This can be done on the fly, requiring little additional resources. The SIS application can have a common dictionary or lexicon, in which the author can add new words. The sorter generally also prepares a list of words offset into the index. When the document is published say as a web page, the index with lexicon is updated in the search engine master, e.g. by merge and rebuild. The updated index and the lexicon in a search engine can then be used by a searcher run by a web server. Preferably, there can be an associated ranking algorithm, to rank the pages according to hit. The hit data can also include a record of links in the documents, parsed by the SIS application in a links database used to calculate a rank e.g. PageRank in Google.

A major advantage in the disclosed method is elimination of crawlers, store servers and repositories, freeing up huge resources. A major disadvantage of these components in the centralized search engine is that these mainly result in duplication e.g. storing and caching the indexed content already published on the internet and hence already stored in a web server. Thus, by decentralizing vital tasks of creating and storing distributed indexes through preparing them in the background while authoring (and preferably while spell-checking the documents), the disclosed new search model can more effectively address the goal of Web 3.0 by becoming more searchable. In this way, the present invention can minimize the problem of lag in indexing all of the ever increasing contents on the WWW i.e. the deep Web by removing the theoretical and practical impossibilities in the huge resources required in existing centralized and distributed models. Moreover, by providing more control in the hands of authors, the present method also avoids future IP issues e.g. copyright issues inherent in the crawler based search models. Further more, even a part of the document e.g. a specific paragraph can be included or excluded in the index, to make that part searchable or not.

Another advantage of the disclosed method will be spellchecking of each term before indexing. As present, there remains a good probability that a term may be misspelled and thus not indexed as per the correct spelling of term. For example, if a search is conducted on Google.com for the misspelled word ‘sceince’, more than two hundred thousand valid results are displayed, because the authors have apparently misspelled the word science as ‘sceince.’ The present method will avoid this possibility by prompting correct spelling suggestion before indexing the term. For example, at the time of authoring a web page if the author spells the word as ‘sceince’, the spellchecker-cum-indexer will prompt the author to check if the intended word was actually ‘science’, and if that is true, the correct spelling is substituted and the term indexes accordingly.

The present invention contemplates a distributed computing model for search engines in which the content writing software i.e. web mastering or authoring tool includes an indexing and sorting application compatible with a search engine, so that the web pages are partitioned and indexes made in the background word by word instantly on entering the text in the authoring-cum-indexing software. This can be preferably and advantageously done offline applying an authoring program with an inbuilt spellchecker associated with an indexing and sorting application (SIS), which builds a forward and inverted index at the time of authoring and spellchecking. Since the spellchecker program has a searchable directory of natural language terms generally in the form of hash tables, the same is advantageously replaced or synchronized with a search engine lexicon which also has natural language terms as well as man made terms such as proper nouns etc. At the time of publishing the content on the WWW, the index is also published and updated, using file transfer protocol (FTP) for example. The said index associated with the said content can be hosted in the same or different servers where the content is hosted, preferably as distributed hash tables, connected and updated in a master on a searcher of a search engine, by merge or rebuild. This obviates the need for spidering and crawling by the search engine, removing the time lag between content upload and searchability, makes all content as per website's policy searchable and has many other advantages.

### BRIEF DESCRIPTION OF THE DRAWINGS

FIG. 1 is a flowchart depicting the prior art and proposed search processes.

FIG. 2A is a schematic diagram showing present search engine architecture

FIG. 2B is a schematic diagram showing broad example architecture

FIG. 3 is a flowchart of the indexing process

FIG. 4 is a simplistic example embodiment of the indexing process

FIG. 5 is an example schematic representation of an embodiment process

FIGS. 6A and 6B are schematic representations of program architecture

FIG. 7-12 are example screenshot impressions

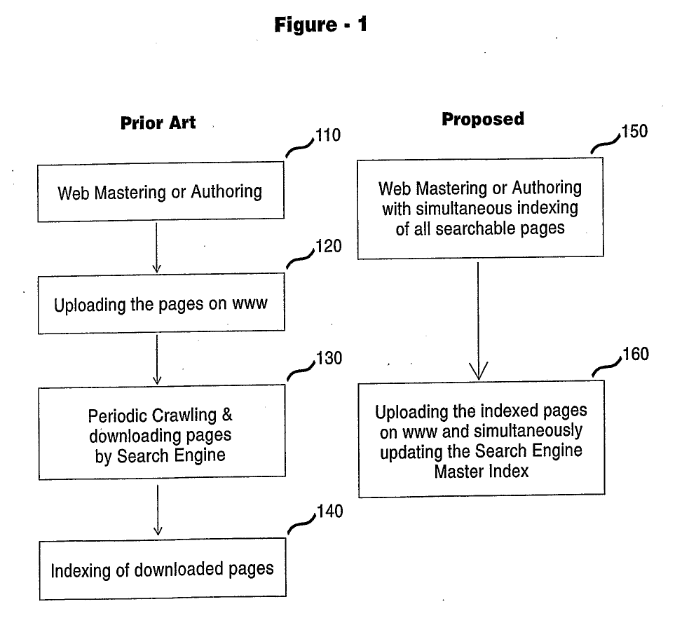

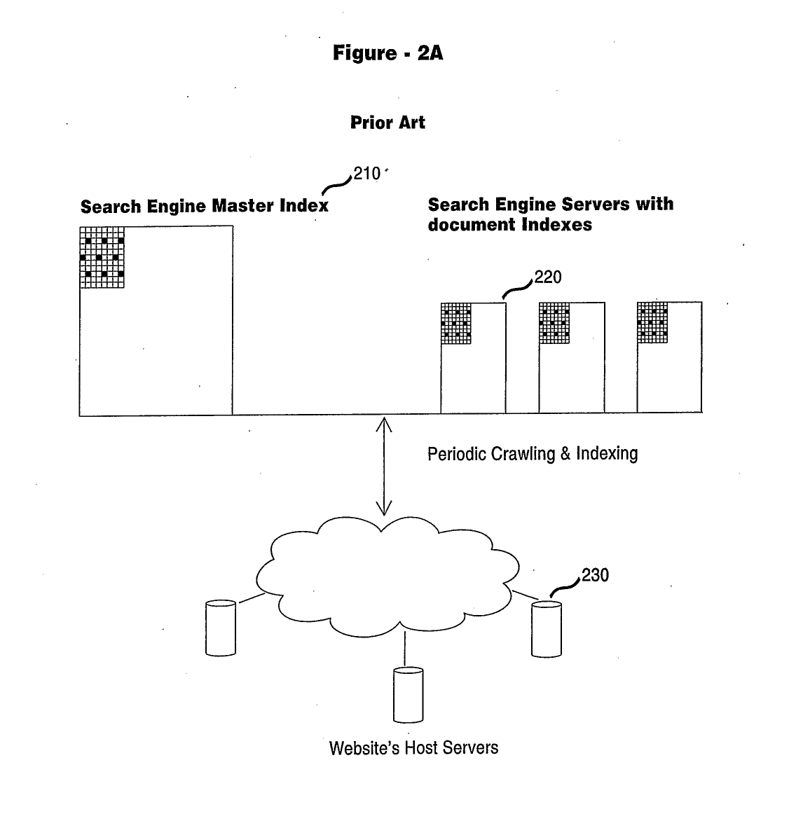

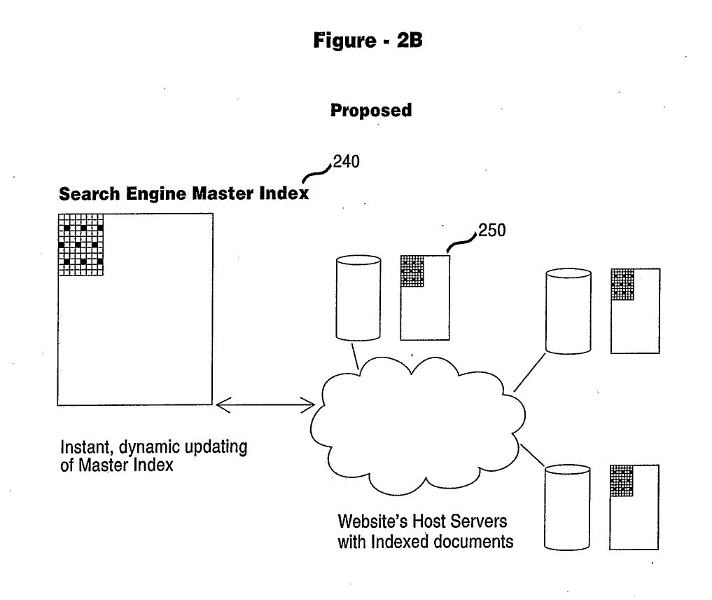

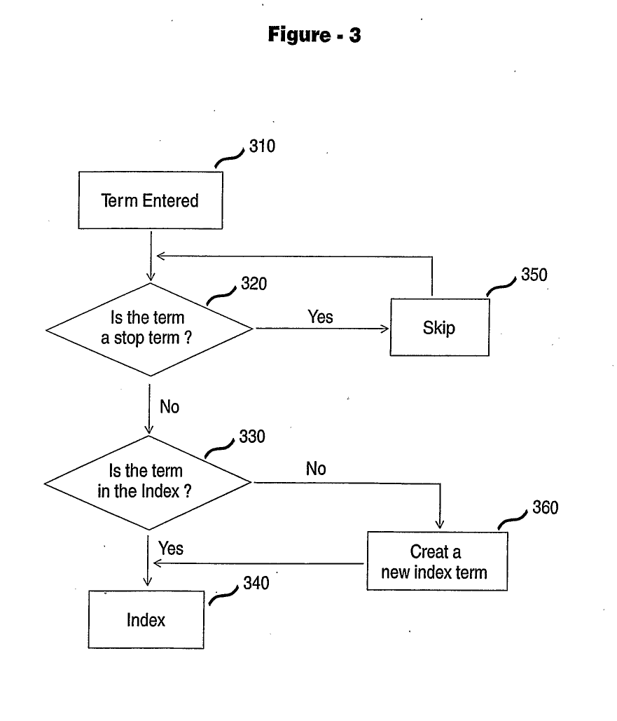

### DETAILED DESCRIPTION

Text editors like HTML, markup languages like XML and web scripting language like Java Script etc. are used for authoring web pages. Authoring tools like Dreamweaver of Macromedia for example can be used to author a webpage conveniently. Such authoring tools generally have inbuilt spellchecker application, to check the spelling of the text matter in a page. The authoring tool may also have a syntax checker which may work on the same lines as the spellchecker, to check the syntax error, if any, in coding on the page. The spellcheckers usually have an inbuilt lexicon of words. As per the present invention in an embodiment, the spellchecker lexicon is synchronized with a search engine lexicon, which may also include words generally not found in natural language dictionaries e.g. proper nouns etc., such as that utilized in ‘Did you mean’ type spellcheckers in Google or ASP Spell Check of Microsoft. The spellchecker in the authoring tool is associated with an indexer and sorter application, which create forward and inverted index of words in a document being authored, in the background. In the preferred embodiment, the associated spellchecker, indexer and sorter (SIS) application in the authoring tool checks the spelling of each term, before creating forward and then an inverted index of each document and word respectively.

For example, popular HTML editors like Dreamweaver, webPage HTML1.8 WYSIWYG editor of AiMCo have built in spellchecker, auto complete, dictionary and thesaurus, which can be synchronized with a search engine lexicon and meta data for context sensitivity. The associated SIS can then build indices in the background, as mentioned. The said indices are then also published on the Internet, at the time publishing the new or changed content. The said publishing of the index can be at the same host server as the content or different servers in a distributed computing structure. Alternatively or additionally, the said publishing can also update a centralized search engine servers, in a centralized computing mode e.g. of Google, obviating crawling, storing, compressing, decompressing etc., saving substantial resources.

In an example embodiment, the spellchecker can have a vocabulary or dictionary, which is synchronized with the index of an associated search engine in a way that the terms in the two are the same on each synchronization. In an example embodiment, whenever a new term is included in the search engine master index, the same is updated in spellchecker vocabulary as well, e.g. by automatic update when a user using the authoring program with SIS application is online. When the text is entered in a document online or offline, each term entered is looked up for matches in the said vocabulary, for spell checking. For example, in Google toolbar plug-in the spellchecker checks the spelling of terms entered online, by a web API that checks the term entered with an HTTP post to http://www.google.com/tbproxy/spell?lang=en&h1=en. In an example embodiment, a web document e.g. a blog created online with such a spellchecker can be also indexed simultaneously on the fly. In an embodiment, on completing spell-checking of each term, the same can also be indexed in the search engine, e.g. by mapping the spell-checked word as a hashed key in a bucket to the document Id as the corresponding value pair, and preferably the other way round as well i.e. mapping the document as the key to the term as the value, e.g. applying map reduction, in the background. A spellchecker based on the lexicon of a search engine e.g. Google's spellchecker is based on occurrences of all words it indexed on the Internet, including common spellings for proper nouns (names and places) that might not appear in a standard spellchecker vocabulary. If there is any new term in a document that is not in the search engine lexicon yet, the same can be added by the author in the SIS vocabulary of the authoring tool and later updated in the search engine lexicon e.g. by merge or rebuild. The search engine lexicon can then be further synchronized with SIS vocabulary of all users online, as per different synchronization protocols and autonomous routines. In an example embodiment, the present invention can effectively work in conjunction with the present crawling based search engines, in which case documents dynamically indexed and updated in the search engine as disclosed can have a protocol e.g. to be saved with a specified marking, so that the crawler application automatically knows that such pages need not be crawled, e.g. by Robot Exclusion Protocol.

In an example embodiment, the URL may be used as docID which can be later associated with a different docID number by a Search Engine program. In one embodiment every web page has an associated ID number as a docID which is assigned whenever a new URL is parsed as a webpage by the spellchecker-indexer-sorter (SIS). The SIS performs a number of functions in the background, including spellchecking, indexing and sorting. At the time of authoring, it parses each document to convert into word occurrences called hits. The hits record the word, its position in document, an approximation of font size and capitalization. The indexer keeps these hits into a bucket creating a partially sorted forward index of the docs. The SIS can perform another important function. It parses out all the links in every page and stores important information about them in an anchors file and posts in a centralized anchors database. This file contains enough information to determine where each link points from and to, and the text of the link. The links database may then be used to compute page ranks for all documents.

The Sorter in SIS takes buckets which are sorted by docID and re-sorts them by wordID to generate the inverted index. The sorter also produces a list of wordIDs and offsets into the inverted index. A program takes this list together with the lexicon produced by the indexer and generates a new lexicon to be used by the searcher. All this is done in the background, while authoring documents, so consuming little resources. The searcher is run by a web server and uses the lexicon built by the program together with the inverted index and preferably with a page-ranking program, to answer queries.

Basically, a hashing function (algorithm) to hash the keys into hash buckets with a list of key value pairs is generally applied in a hash tables (lookup tables) common to spellcheckers and search engine. By optimizing both in a single interrelated application, surprising economy in effort and resource requirement can be achieved. For example, HashTrie of Softcomplete Development has combined properties of the hash-tables and trie (digital-trees), with a flexible size. Such structures can be suitably adapted in developing applications as per the present disclosures.

Generally a spellchecker program has a lexicon also with inflexion rules etc., which can be advantageously utilized in a related semantic type search engine algorithm. In an example embodiment, an advanced spellchecker associated with a grammar checker with high level of semantic information and disambiguation capability in built, can be scaled up to also provide for highly context sensitive search engine application. word by word, an API if enabled first checks if the term is a Stop word like ‘is’ etc. which need not be indexed (320, 350). However, if the term is not a Stop word, the API checks if the term is in the index (330) and if yes is indexed (340). If a search term is not included in the index, a new index term can be added and a log maintained. The term index is preferably based on a vocabulary synchronized with a search engine lexicon, so as to include all known words as per dictionary or as per historical experiences of search engine. In an alternative embodiment, stop words can be also included in the index if desirable, e.g. in semantic type search engine algorithm.

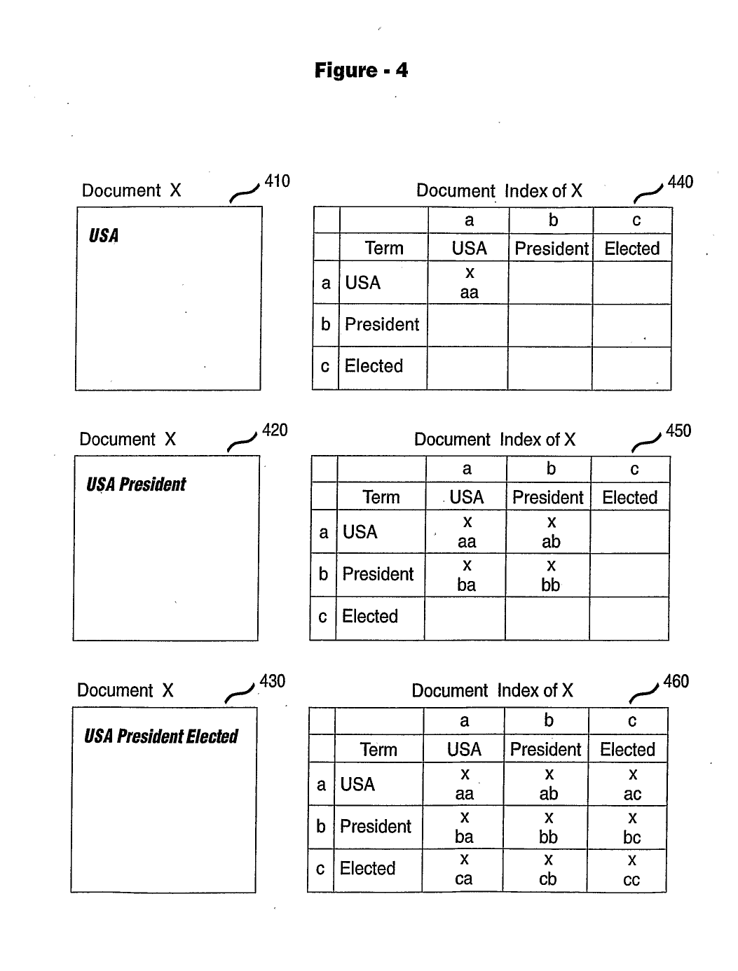

In a simplistic exemplary embodiment depicted in FIG. 4, as the searchable terms are typed and preferably spell-checked by the SIS application, the same is indexed in a forward index of the document and sorted as an inverted index of the word with pointers or connecters to the document, in a hash table preferably. For example, if ‘USA President Elected’ is typed while making a document X, the words USA (410), President (420) and Elected (430) are updated in the forward index of document X, in the steps 440, 450 and 460. In example embodiment, forward and inverted term indexes are created in the background at the same time when the document is authored. At the time of publishing the document, the document index is also published e.g. as a chunk in a distributed computing model, and the search engine master or manager is updated.

Apart from freshness and currency (e.g. in breaking news context), it will save expensive overheads by eliminating the need for centralized spidering, crawling, indexing in the present search engines. An indexing and sorting application preferably associated with a spellchecker can operate in the background while authoring of the content offline or online, and then the index so prepared that the preferably spell-checked documents are published online, preferably together. The index so prepared can feed into a centralized search index database or into a distributed database such as that in Google File System (GFS). GFS, for example has a master, which controls chunks in clusters. The document indexes prepared as per the present disclosures can be analogical to Chunks, stored in Clusters managed by masters. Map Reduction technique of GFS e.g. can be used for example to map terms to document index prepared as disclosed and stored in chunks and clusters, and then aggregate and feed the data in the master, for mapping e.g. which term is in which document index through a big table.

Generally speaking, modern search engines prepare an inverted index of documents containing the search words, by spidering, crawling, parsing and caching, and then rank these documents by relevance. Because the inverted index stores a list of the documents containing each word, the search engine can use direct access to find the documents associated with each word in the query in order to retrieve the matching documents quickly. The following is a simplified illustration of an inverted Boolean index:

| Word | Documents |
|---|---|
| The | Document 1, Document 3, Document 4, Document 5 |
| United | Document 2, Document 3, Document 4 |
| States | Document 3, Document 5 |
| President | Document 3, Document 6 |

The inverted index is a sparse matrix, since not all words are present in each document. The inverted index can be preferably in the form of a hash table or a binary tree, which requires additional storage but may reduce the lookup time. In larger indices the architecture is typically a distributed hash table. Inverted indices can be programmed in several computer-programming languages.

The inverted index produced dynamically while authoring a document as above can be updated in a search engine master via a merge or rebuild. A rebuild is similar to a merge but first deletes the contents of the inverted index. The architecture may be designed to support incremental indexing, where the merge identifies the document that is already parsed, indexed and published with the associated index as above. In the crawler based methods, a merge conflates newly indexed documents, typically residing in virtual memory, with the index cache residing on one or more computer hard drives and after parsing, the indexer adds the referenced document to the document list for the appropriate words. As per the present invention, since the document is already parsed and indexed in the background, when the document is published (uploaded) e.g. through FTP, an associated application adds the document reference in the inverted master index of parsed words. If a parsed term is not found in the master index, the same is added by the application, in the lexicon of the master. At this stage, another application may be triggered which logs an instant or pending routine to add the said new term in a spellchecker dictionaries of the authoring tool, e.g. by synchronizing it with the master dictionary whenever the authoring node is online, autonomously or on user prompt.

In a larger search engine, the process of finding each word in the inverted index (in order to report that it occurred within a document) may be too time consuming, and so this process is commonly split up into two parts, the development of a forward index and a process which sorts the contents of the forward index into the inverted index. The inverted index is so named because it is an inversion of the forward index. The forward index stores a list of words for each document. The following is a simplified form of the forward index:

| Document | Words |
|---|---|
| Document 1 | the |
| Document 2 | united |
| Document 3 | the, united, states, president |
| Document 4 | the, united |
| Document 5 | states |
| Document 6 | president |

The rationale behind developing a forward index is that as documents are parsing, it is better to immediately store the words per document. The delineation enables Asynchronous system processing, which partially circumvents the inverted index update bottleneck. The forward index is sorted to transform it to an inverted index. The forward index is essentially a list of pairs consisting of a document and a word, prepared by the SIS application in the background. Converting the forward index to an inverted index is only a matter of sorting the pairs by the words, which is also accomplished by the sorter in the SIS application. In one way, the inverted index is a word-sorted forward index. As per the disclosed method, the document is parsed dynamically in the background while authoring, and preferably while also spellchecking, and a forward and inverted indexes are prepared on the fly, eliminating the need for spidering, crawling, caching, parsing and then indexing.

In the above example say in Document 3, as the words The United States President are entered e.g. by typing, each word is spell-checked in the background and a forward index for Document 3 is populated to include the terms the, united, states, president, and is inverted into a term index containing each of the terms the, united, states, president, to point to Document 3, in an inverted index as shown above. This way, an indexing application works in the background, preferably associated with a spellchecker application, having common or synchronized vocabulary or lexicon. If a new term is entered, say in document 3 ‘Obama’ is entered after the above words and the same is not in its dictionary. At this stage, the application prompts user if he or she would like to ‘Add’ the new term not found in the dictionary. The author may decide to add the term in which case the same is indexed in the forward and inverted index, with the new term with a tag to indicate it is new. When the document is published online and the index is updated in the search engine master, while the existing terms are updated by merge and rebuild, the new term, e.g. ‘Obama’ is also added in its lexicon. In an embodiment, the dictionaries of authoring program of any other authors online at that time or subsequently are updated by adding the term ‘Obama’, e.g. by synchronizing. In preferred embodiment, as the authoring-cum-indexing program used by the authors is also associated with a spellchecker, spelling suggestions like Bema, Omaha etc. are also prompted while offering to ‘Add’, as in spellchecker applications, with the important difference that in either selection, the background indexer and sorter will be working. In an example embodiment, the SIS application is programmed to work online, using the corpus of search engine lexicon as its vocabulary, in which case any added published and indexed term like ‘Obama’ in the above example is available as a recognized term in the spellchecker-cum-indexer application instantly for all subsequent uses and users.

In an example embodiment, a trie-based algorithm also known as radix sort can be advantageously applied in spellchecker application as above, for lexicographical sorting of all words as keys, which can then be hashed for the document as the value, by an associated indexer application, both applications working in tandem in the background, as explained.

The disclosed method will also be advantageous in a dynamic content situation, where the content provider can provide better control on whether and which dynamic content is to be searchable e.g. partly e.g. providing frequently searched dynamic content within the index or suitable linkages to less searched dynamic content but still available for searching by a searcher. The present centralized models have serious limitations in terms of crawling, indexing and prioritizing dynamic content pages.

Since those who host web contents also have a need to become searchable, incidence of computing and related costs can be advantageously shifted on them partly. In an embodiment, the such individual indexes can be maintained with the hosted content in the same or different servers, and the search engine algorithm is programmed to relate to these dispersed indexes in different host locations, optimized in a distributed search model, thereby avoiding a huge infrastructure cost and other risks inherent in centralized system e.g. of monopoly and trust, breakdown etc. In another embodiment, the individual search indexes of each document published as above can be also published instantly in the centralized index database of a search engine. A combination of both embodiments can provide better integration with legacy search engines, crash protections and lesser downtime risk. Data accuracy is also improved.

Advantages will include the content provider will be able to exercise greater controls e.g. whether to restrict or allow indexing of parts of information that might have confidentiality concerns e.g. dynamic databases related content or those on robot.txt files e.g. in Government websites. Content publishers will also contribute and gain better control on being able to be searched and also know the probable searcher directly, unlike in the present model where third party search engines have prerogatives.

Conceptually, the disclosed method is akin to publishers providing term indexes e.g. the back of the book indexes, which are merged into a master index for a search engine.

A new software as per these disclosures will include a web-mastering tool like Dreamweaver or FrontPage that generally uses HTML languages, and a document partitioning and indexing tool e.g. Java based, to create or update a website search index simultaneously while authoring a change or a new content, offline or online. The indexes so created are as per the indexing logic of a search engine. The search engine index files associated with the distributed logic is uploaded at the time of publishing of the content. In one embodiment, the distributed indexes can act as caches for the master in the search engine. In another, the distributed website indexes are updated in a search engine manager, each time a new content is added or updated, eliminating the need for spidering and crawling like at present. Thus, the time lag between publishing of changed or new content and indexing is also minimized or even eliminated.

Proprietary software like this can have in-built tools to avoid being misused for frivolous uploads just to artificially increase search popularity of a document, with protection against tinkering. For example, it will keep a log of last change or new content upload from the host and compare it with the latest change to restrict or eliminate frivolous attempts.

In other embodiments, the module can be programmed to build the document index at selectable options of intervals e.g. instantly on typing a word, line change, document completion and/or randomly at the earliest the resources are freely available, etc.

The techniques disclosed here could be adapted as a new authoring-cum-indexing tool for webmasters, to make all their authorized content searchable, which could be a solution for the increasing deep web problems. There can also be a module in the SIS to run and rebuild existing content e.g. legacy content.

The technique can be integrated with the present search engines to reduce the pressure on crawling based models. A sitemap protocol can include the information about those documents, which are dynamically indexed and updated as per the present disclosures, to direct crawlers to only those documents elsewhere that might not have been dynamically indexed. The dynamic indexes built and published by the webmasters can be maintained in an auxiliary index periodically updated in the master.

The present invention discloses a new web mastering or authoring software associated with search engine software, to include a document processor for dynamic and simultaneous spellchecking, indexing and sorting of documents while the documents are authored, and for publishing the document indexes with the documents, and for synchronizing with search engine master index.

In example embodiments, grammar checking and other morphological capabilities of spellchecker programs like hemming etc. can be effectively utilized in indexing as well. One of the advantages in this would be that a word sense disambiguation (WSD) capability can be built in grammar checker's natural language type processing (NLP), without much extra duplication of programming and other resources.

In a simple example architecture, the inverted index for all the searchable content is stored in distributed servers, controlled by a manager in a search engine. In another embodiment, the indexes are merged or rebuilt into a centralized index. The index generally has an exhaustive in-memory hash table of words. The index can also have disk-based storage of the rowIDs or pointers to the page locations that match each word. Whenever a document is authored, edited or deleted, an index is created in the background and when the same is published or updated, the index database is updated by merge or rebuild. The hash tables have flexible structure, to accommodate ever-growing dictionary. The search engine servers can process queries, and can monitor the distributed or centralized index databases for changes. This is done, for example, by looking for new rows in a primary table or a new row in an Updates table that can be used to trigger the search engine manager or master to re-index existing rows. To process search queries, an inverted index algorithm such as that in Managing Gigabytes can be used, for example, whereby a query is broken into terms, and each term is used as a key into the in-memory hash table. The hash table record can contain the count of how many rows matched that word and an offset to the disk to read the full ID list. The service can then iterate through the words to efficiently intersect the lists. A ranking algorithm can preferably rank the pages according to perceived relevance.

Since the context of the contents is known at the time of making the page, context based master or meta indexing will be also possible, e.g. meta tags provided by the author, which again can be program driven in the SIS application. The processing power of modern computers has enough parallel processing capacity to be able to enable authoring and indexing at the same time or word-by-word at the time of entering the text.

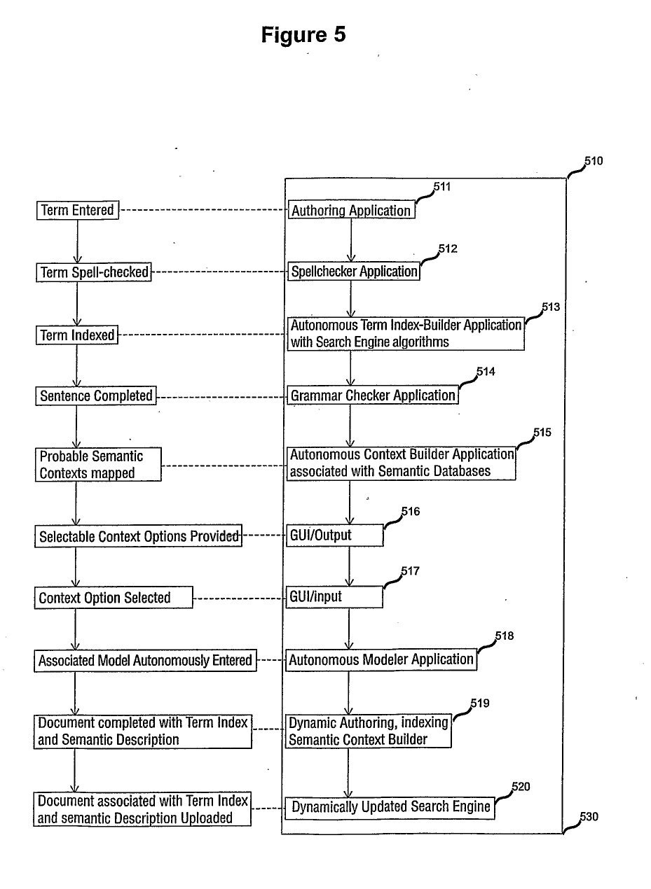

A schematic presentation of an exemplary embodiment of the process is described as per FIG. 5, as per which a term is entered through an authoring application at 511. As soon as the term is entered, it is spell-checked by a spellchecker application at 512. The term is then indexed by an autonomous index builder application, as per a search engine algorithm, at 513. A grammar checker application checks the grammar of a sentence completed at 514. Probable semantic contexts are mapped by an autonomous context builder application at 515, and these are prompted as selectable options through a GUI output device. The author may select an option and input it through GUI input, upon which the context selected, is automatically entered. This can be in the form an associated model, which can be selectively entered by an autonomous modeler application. This way, while the document is authored, not only is its spelling and grammar checked in the background, a term and semantic index is also built in the background. When the document is published on the internet, the index or indexes can be also published and updated in a search engine master.

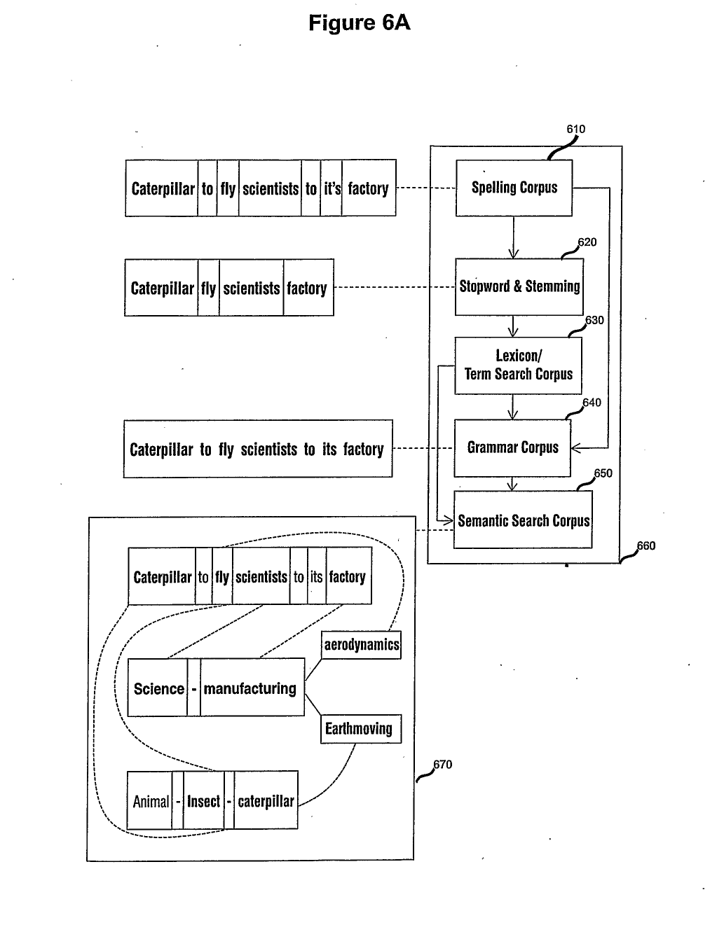

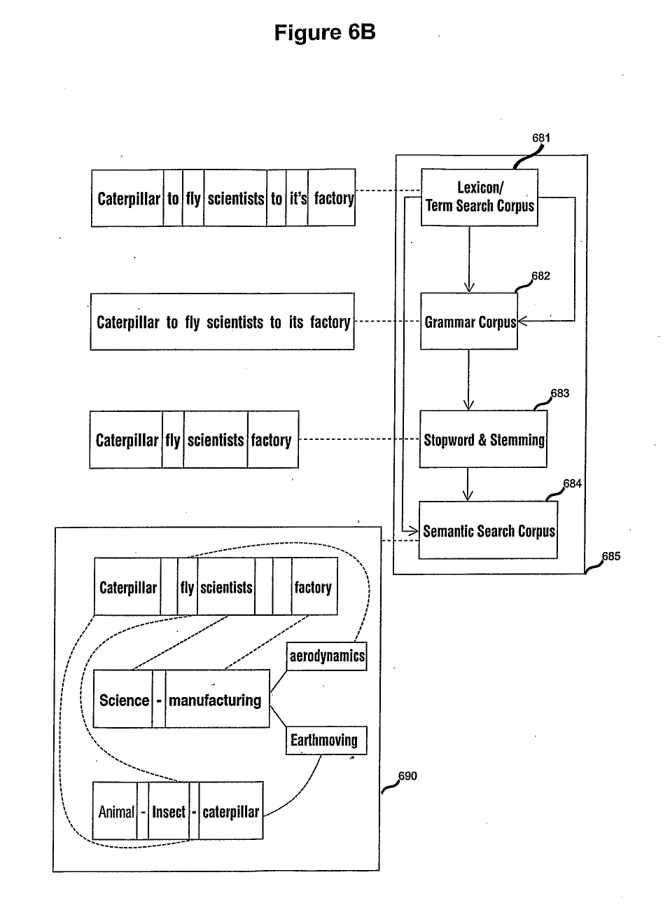

FIGS. 6A and 6B show example architectures of the proposed process. For example, when the sentence ‘Caterpillar to fly scientists to it's factory’ is typed, the spelling of each word is checked in the background at 610, vis-à-vis a vocabulary database or spelling corpus. A stemming program may then identify and exclude the stop words like to, its, is etc., at 620, to index the spell-checked terms excluding the stop words, as per a lexicon or term search corpus at 630. A grammar checker meanwhile checks the grammar of the sentence and suggests changes as per a grammar corpus, for example to replace ‘it's’ with ‘its’, at 640. A context builder then takes over and maps probable contexts, as per a semantic corpus, at 650. There may be also an associated modeler application with a modeling corpus, as described below. The semantic corpus may or may not take into account the stop words, as shown in FIGS. 6A and 6B respectively. As shown in FIG. 6B, the spellchecking and indexing may be performed taking all terms including stop terms, looking up each term in a common vocabulary/lexicon/term search corpus, at 681.

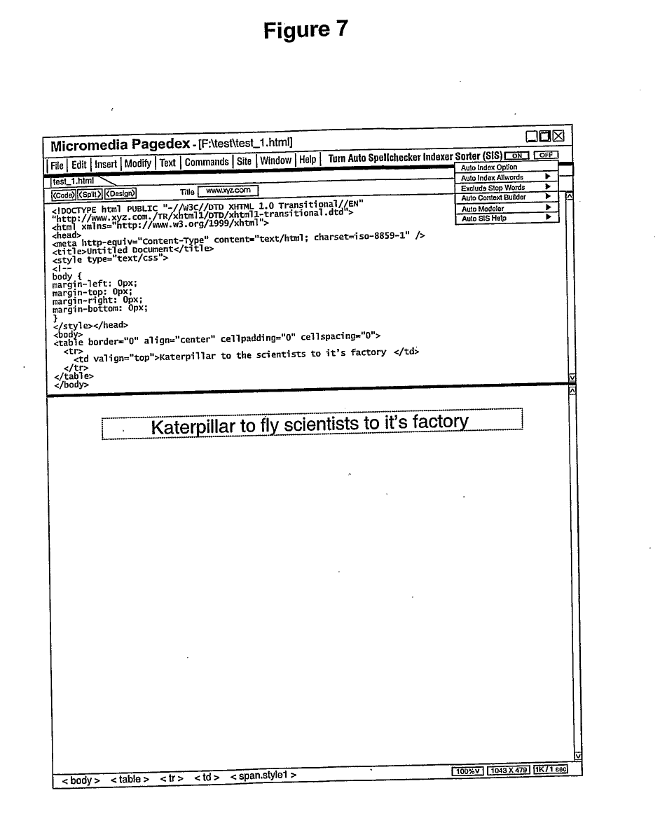

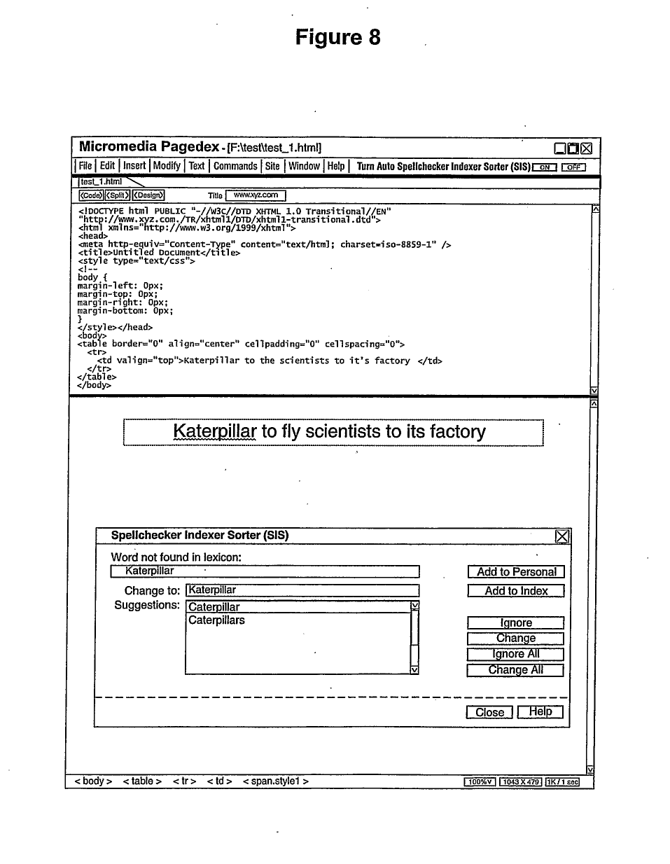

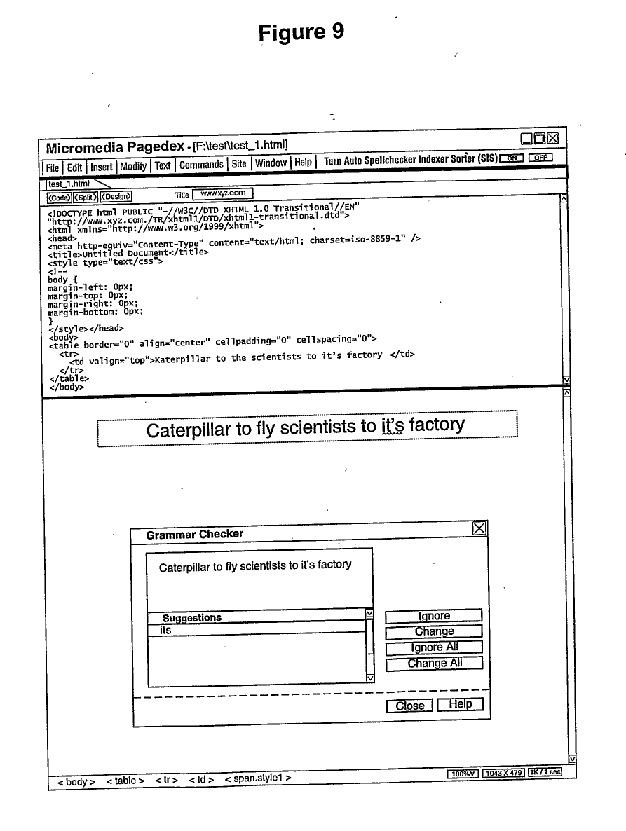

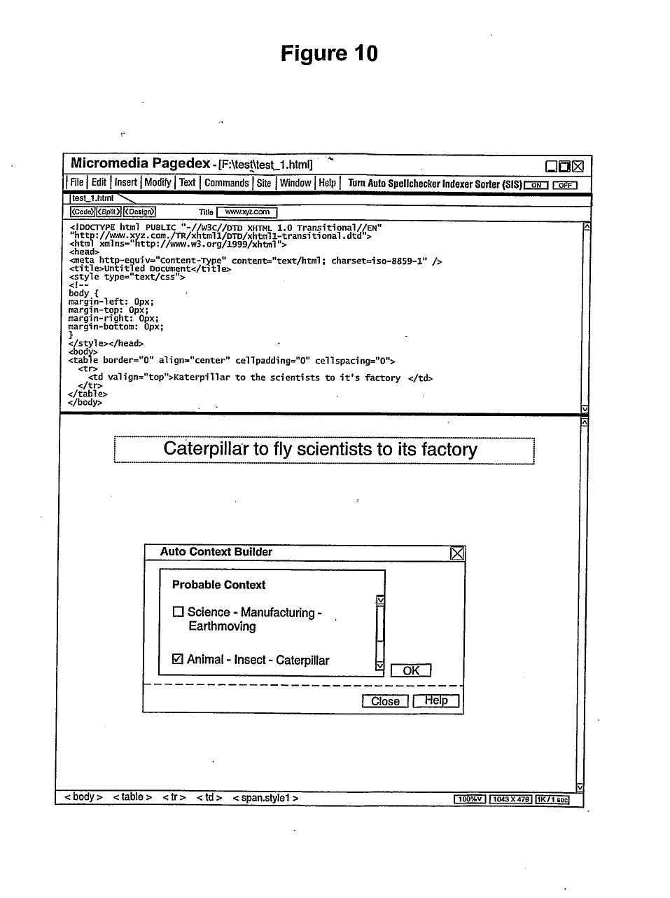

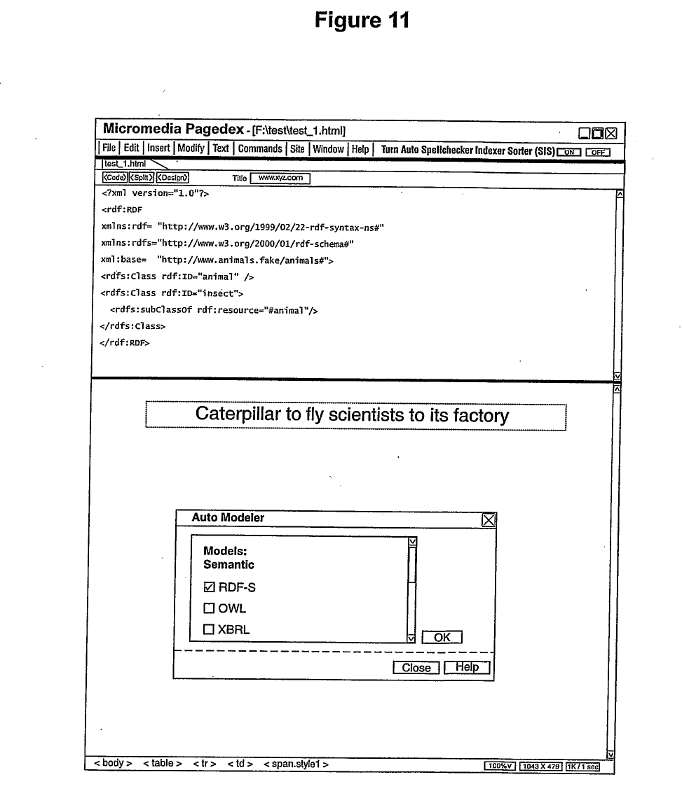

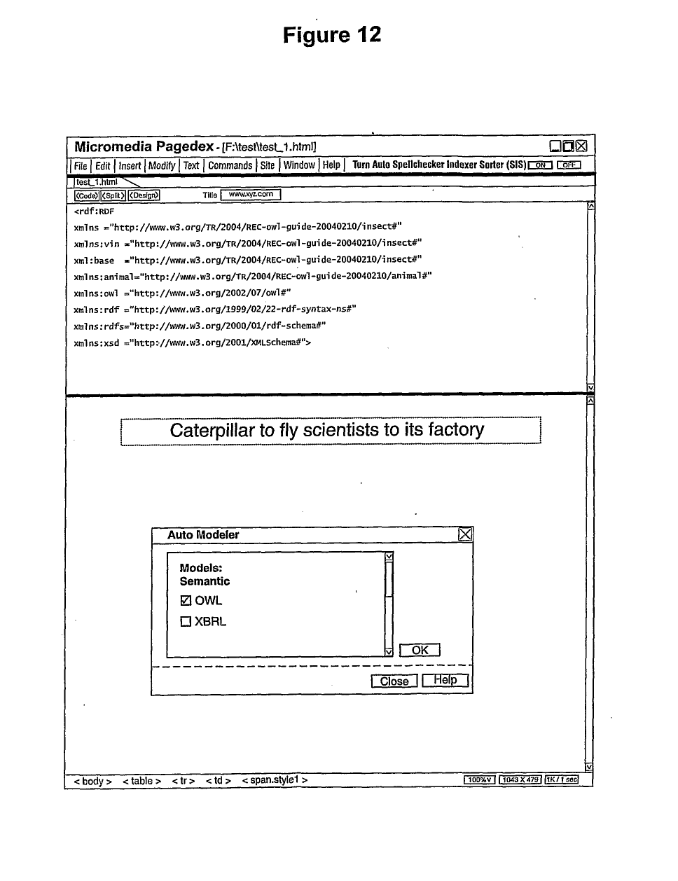

FIGS. 7 to 12 are exemplary screenshots depicting a typical web authoring software such as Macromedia Dreamweaver, with some of the example embodiments of these disclosures. For example, in FIG. 7, the navigation bar has buttons for switching on or off an automatic Speller-Indexer-Sorter (SIS), depicted at the top right hand corner. Let us assume that the SIS is switched on and “Katerpillar to fly scientists to it's factory” is typed, while authoring a web document to be published. As the sentence is completed, the spellchecker in SIS checks the spelling vis-a-vis a lexicon, detects that the term ‘Katerpillar’ is not in the lexicon, and suggests replacement by the word ‘Caterpillar’. The suggested word can be selected, or the undetected word can be added in the lexicon, as explained. Let us assume that the suggested word is selected or K is replaced by C in the incorrect term Katerpillar, as in FIG. 8. At this stage, as per the optional setting of the SIS, a Grammar checker checks the sentence and suggests replacement of ‘it's’ by ‘its’, as shown in FIG. 9, which is done. In another embodiment, the spellchecker and grammar checker can suggest the changes as above in one go. Now as per the optional setting of the SIS, an automated context builder may detect most probable semantic context, based on relating the sequence of words in the sentence, as explained above and as shown in FIG. 6, to suggest probable alternative contexts of Science-Engineering-Earthmoving or Animal-Insect-Caterpillar, as shown in FIG. 9. Supposing the author selects the second context i.e. Animal-Insect-Caterpillar, as shown, an automatic modeler can then offer options for various models e.g. RDF-S or OWL or XBRL etc., as shown in FIG. 10. Assuming that RDF-S is selected, as shown in FIG. 11, the related schema is automatically entered, as shown. However, if OWL is entered, in the alternative or in addition to the RDF, the same is populated automatically, as shown in FIG. 12 for example. This way, the complex tasks of Spellchecking, Grammar checking, Semantic Context building and Modeling can be greatly automated and performed, apart from Indexing and Sorting as explained, in the background, while authoring content. This may be advantageous over the state of the art methods, by obviating the need for not only crawler based indexing, but also operator based context building and modeling, which are further automated, associated with automated spellchecking, indexing and sorting.

In reply to: one embodiment, the so-called stop words can also be a part of indexing as above, as there is very little additional requirement of resources as per the method disclosed herein. Consequently, if for example a sequence of words including stop words is entered as a search query, e.g. a sentence or a part of a sentence, the search engine can find exact or closest match of that string of words including the stop words. This way, a more semantic type search will be made possible, because a search based on sentence or a part of sentence match will be more likely context specific. For example, say a search query ‘Caterpillar to fly’ in the prior art search engines returns results related to caterpillars and flies—both in the context of insects. However, as per the present method of parsing sentence parts including stop words like ‘to’ will ensure that the search result will return an item like: ‘Caterpillar to fly top scientists . . . ’, with a high rank. Optionally, a feature like this can be advantageously associated with grammar checker applications that typically find each sentence in a text, look up each word in the dictionary, and then attempt to parse the sentence into a form that matches a grathmar, e.g. by applying exact phrase type search options. For example, if in the above example situation the sentence were ‘Caterpillar to fly scientists to its factory’, a search query like Caterpillar to fly scientists to their factory’ will return Caterpillar to fly scientists to its factory at high rank, unlike the search engines which may not take stop words ‘to’ into consideration, and may still return searches in the context of insects high, e.g. information about a hypothetical factory with scientists working on flies and caterpillars, Moreover, the parsing of ‘Caterpillar’ with the associated word ‘to’ will mean a kind of context rejection of insect, as the associated phrase ‘caterpillar to’ is unlikely to have been used in the context of insects. This will be advantageous in that the full index is prepared at the time of authoring and thus is provided by the publisher of the content, without the extra effort in Crawling or in RDF or OWL type annotation in bottom-up and top-down approaches in the prior art semantic search methods.

In another embodiment, the method can further include dynamically relating to semantic contextual information related to other semantic search models, e.g. RDF, RDF Schema, OWL, XBRL etc. This can be done by an application dynamically relating the indexes created as above to a semantic meaning database

as per a semantic model such as a resource description framework or a schema or an ontology or a taxonomy in the background. Then a GUI applet can prompt the author to optionally select or confirm a related information modeling and if selected the said information modeling is populated for the term or the sentence or the page, as per the model. Like the spellchecker or the grammar-checker application dynamically relates words and sentences entered with a database of words and sentences in its memory, this application can dynamically relate the Words and sentences to pre-stored semantic models in its memory and then prompt the author to select preferably from closest matches of resource description or other information as per a model or meta model. For example, the associated spellchecker, grammar checker and indexer application as described above can further include controlled vocabularies, taxonomies, thesauri, models and Meta modelers, to dynamically relate each word, phrase and sentence checked by spellchecker and grammar-checker, with the databases of controlled vocabulary, taxonomy, ontology, model and meta model, and apply a probabilistic or heuristic technique for autonomously suggesting semantic models. For example, when ‘net profit’ is typed in a document, the spellchecker first checks the words ‘net’ and ‘profit’, while indexer-indexes the terms ‘net’ and ‘profit’. Then the spellchecker associated with the indexer triggers checking the phrase ‘net profit’ in the background to relate it with a meta model database e.g. a taxonomy database such as that of XBRL, and if a match is found e.g. for ‘net profit’, a GUI prompts the author to optionally select the match for marking the data accordingly.

In various embodiments, context logics of various techniques like neural networks, vector builders, and relative proximity etc. can be advantageously associated with the interrelated spellchecker, grammar checker and autonomous term index builder applications, to build a context framework in the background autonomously, to optionally provide probable context choices built, so that the author could optionally select the closest context choice, upon which the selected context is saved associated with the document. When the document is published, the context description saved is also published, in the dynamic search engine as per these disclosures.

In an example embodiment, if ‘Caterpillar to fly scientist to its factory’ is entered as per the example, the autonomous modeler can relate the document to a context other than the above, based on a different probabilistic model, to relate to say, Science-Manufacturing-Aerodynamics or, Science-Technology-Manufacturing-Caterpillar, as shown in FIG. 8. Such modeler can be completely automated or programmed to provide most probable options selectable by the author. Such autonomous probabilistic or heuristic modelers can further be provided with machine learning capability. For an example, the dictionary database entry of ‘Caterpillar’ in the spellchecker can be associated with the meta model string in the contexts such as that of -Animal-Insects-Caterpillar- and -Earthmovers-Caterpillar- etc. The word Fly in the dictionary can be associated with the strings -Animal-Insects-Fly- and -Manufacturing-Aerodynamics-Flying- etc., for example. Likewise, the term Scientist is associated with -Science-Scientist- and Factory with -Manufacturing-factory etc. as hypothetical strings. An autonomous context builder can parse the various associations and prompt most logical choices e.g. on the basis of maximum interconnected branches encountered in a document. Thus in the above example, it builds alternative contexts of -Animal-Insects-Caterpillar, Science-Manufacturing-Aerodynamics or, Science-Manufacturing-Caterpillar as probable. However, the whole sentence may be checked in relation to a thesaurus or an ontological database of sentences, and if the phrase or the sentence ‘Caterpillar to . . . ’ or the capitalized C in Caterpillar is not matching as per thesauri or ontology of the domain related to the string -Animal-Insects-, the option is rejected. Likewise, if the phraseology and sentence structure is found conforming to thesauri or ontology of the other two probable strings as above, the same are prompted as options. On the author confirming one of the options, the application can further offer machine-learning option, which if selected can suitably add the experience in the ontological database, e.g. the semantic context of example sentence will be prompted as most likely in future, as per what has been selected now. Thus, semantic ontological references related to each document can be presented as an additional layer of information generated as above, in addition to the term indexes as discussed above. Further, there can be option to lock the context so identified, for a session, to save resources if desirable e.g. in a fixed context.

Further, the modelers can have universal or specific metamodel options selectable by an author. For example, an author working in the domain of medicine can optionally select the always-on type meta-model or specific model or ontology or schema appropriate for his or her domain, to save on computing and other resources.

In an embodiment, there can be a relational database of controlled vocabularies, taxonomies, thesauri, ontology, models and meta models, associated with the natural language databases of spellchecker and grammar checker, to dynamically process probable semantic context models, based on frequency of a controlled vocabulary term or taxonomy of a phrase or ontology of sentences in a document. For example, say if ‘Caterpillar’ is typed in a document a number of times, the background application associated with a spellchecker, indexer and an autonomous probabilistic modeler can determine if the most likely ontological context is that of Animal-Insect-Caterpillar, and prompt the author accordingly at the time of saving the completed page offline or online. If the author selects say, by selecting Animal-Insect part of ontology prompted by a GUI, the RDF Schema for example automatically entered, as shown in FIG. 11. In addition to or rather than RDF-S, the semantic description so populated could be other like that in OWL, XBRL etc., as may be desirable, as shown in FIG. 12.

A structured set of text in the form of a corpus is generally associated with a spellchecker or a grammar checker application. Search engines build on their own corpus, which can be a term corpus, or a semantic corpus. One of the distinguishing features of the present application is to provide synchronized common corpora, to dynamically index in the background while authoring, leading to more pervasive and better application or artificial intelligence in semantic searches. There will be little if any extra workload on content creators as per the method discloses herein, with clear incentives like becoming as fully searchable as desired and ability to know the searchers. If applied as per the distributed model disclosed above, it will solve the problems of trust inherent in the present search methods, which tend to be monopolistic. Thus, the method disclosed can reduce deep web as more and more content can become searchable without the present constraints.

In a related aspect of the present invention, the document indexes so prepared can be advantageously secured and utilized to rebuild documents e.g. in case of accidental losses like due to hacking or corruption. Since all pages are indexed as per the present disclosures, the indexes so prepared and stored can be advantageously utilized to reconstruct the text of a document.

In an embodiment, the SIS application may include selecting tags for graphics, sound, audio-video files etc. for indexing, at the time of authoring. Alternative probable tags can be prompted on the basis of context mapped and the file names associated with such files, based on a corpus, as explained hereinabove, in the background, while authoring.

The proposed method may have advantages in view of copyright and other intellectual property related law, as it may be perceived that only an author or publisher has the legitimate right to index.

In an embodiment the content processed by the SIS as explained includes content not necessarily published on www but searchable on the Internet, e.g. books. In an example embodiment, the-content of the book is edited while authoring, including reference information e.g. that provided in front of the book and reference indices provided at the back of the book, preferably spellchecking at the same time. In an example embodiment, a book authoring program e.g. Pagemaker can have SIS capability. The program can further have capability to automatically compound index terms, index prepositional phrases, invert terms and phrases, and support general, subject and name indexes, like in software supported BoB Index builders e.g. TExtract, to automatically build additionally a reference index such as that found at the back of the books, which is also updated in the search engine metadata. This way, if a search is conducted applying a term in the book or its reference index, results include a reference to the book, preferably pointing to related page number, whether or not the content of same is accessible on the internet.

Although the technique disclosed hereinabove is generally described in terms of authoring or editing documents, the same can be applied in other machine based indexing processes of any kind of content e.g. indexing of images. For example, probabilistic models such as those applied in image recognition can be applied, to associate an image with a term or value in an index dynamically at the time of authoring, which can then be inverted or sorted and stored in search engine meta data, making the content readily searchable, without the need for replaying or crawling. The technique can be applied in indexing any other kind of content e.g. while converting speech to text, dynamically at the time of converting, as disclosed. To a person skilled in the art, it will be easily discernible that the invention disclosed herein can be applied in dynamically indexing any kind of content based on an indexing parameter like a lexicon or any other kind of tag such as a pattern or a model. For example, video indexing techniques employed by Google and ClipBlast are based on crawling the web for indexing images with tags sometimes referred as ‘graceful degradations’ whereas the technique disclosed here can be advantageously applied to dynamically index multimedia video content while authoring, e.g. an automated indexer-sorter indexing the image in relation to an attribute such as its tag thus obviating the need to crawl.

In an example embodiment applying the present invention can be applied for dynamically indexing other type of content such as audio-video footage. For example, YouChoose feature in YouTube converts speech in audio-video uploaded, to text and then indexes the text in relation to the audio-video clips. It leads to similar disadvantages explained hereinabove, due to the post-publication type processing has inherent disadvantages of duplications, huge requirement of resources at search Engine, and lag between publishing and searchability. The present invention can be advantageously employed to overcome these disadvantages, as explained. For example, before uploading an audio or audio-video t content, preferably at me time of authoring or preparing or capturing the same, in the background, the audio in the content can be autonomously converted to text and the text processed as disclosed hereinabove dynamically to preferably spell-check, index and sort the same utilizing the SIS, and store in a search engine meta data as per a VDBMS so that when a term or terms spoken and converted is or are searched, the results point to the related segments in the content. The dynamic indexing and sorting as explained can be autonomous or sometimes operator assisted e.g. in case of a dubious machine interpretation. Machine learning capabilities can be further build applying iterative or heuristic techniques. Likewise, video content with textual content or tags e.g. strata can be indexed and sorted dynamically while the content is being produced and published, to become searchable fully and instantly, compared to post-processing or crawl based techniques in the prior art. This way, any audio-video or only audio content published or stored in a computer network will become very searchable in terms of its semantic content. In yet another embodiment, the textual matter related to the shots or frames e.g. in presentation slide can be autonomously captured by an OCR device and indexed accordingly.

It will be discernible to a person skilled in the art that one of the main inventive aspects of the present invention is the concept of dynamic indexing and sorting preferably associated with spellchecking, while authoring or generating a content by the author, because the prior art methods are generally based on centralized caching and post-processing of content, which have serious limitations in terms of duplication of work and storage, delay, unknown context and resulting ambiguity and proprietary issues like possible breach of copyrights etc. Another inventive aspect is in associating spellchecker in an authoring program with the dynamic indexer-sorter. As the spellchecker in an authoring program is able to analyze each term in a document, associating it with a synchronized vocabulary of the indexer-sorter will achieve substantial saving of resources. This way, it will be possible to avoid crawling and caching of content as per an example embodiment of the present invention, leading to unprecedented savings in resources required, making the concept of semantic web practical. Applying these inventive concepts in the context of dynamically indexing any content including audio-video content may provide the much needed quantum jump for search capability of digital content, in a semantic web.

In another example embodiment the dynamic index apart from being updated in the metadata can be also stored locally with the content, making fast search possible locally in the network.

Thus disclosed here is a computer-implemented method of dynamically indexing content at the time of authoring or editing, comprising applying an authoring or editing tool associated with an indexer and sorter application; dynamically parsing, indexing and sorting the content in the background, in relation to a lexicon or vocabulary; storing the content and the related index, and publishing the content and updating the index related to the content, in a search engine manager or master or metadata in a computer network such as internet. The method further comprises applying an associated spellchecker with indexer and sorter and spellchecking the terms before indexing and sorting. The method further comprises synchronizing the lexicon or the vocabulary of the spellchecker and the metadata. The above may further comprise applying an associated grammar checker application and checking the grammar of a sentence optionally. The above methods may further comprise applying a context builder application associated with the authoring program; dynamically relating a term, phrase or sentence, while authoring a document, in the background, to a database of a controlled vocabulary, taxonomy, thesauri, ontology, concept, strata or a modeler in a meta model, autonomously building a semantic context and, prompting the author to optionally select the said context and recording the selected context associated with the said document. The method may further comprise dynamically applying in the background a speech-to-text translation program associated with a an audio-video or audio content, at the time of authoring, editing or capturing content dynamically indexing in the background the translated text in relation to the said content. The methods may further include a module for rebuilding an existing content or legacy content.

The methods recited may further comprise applying an OCR program on graphical content representing text and dynamically indexing in the background the OCR recognized text in relation to the said content. The method further comprises the content being pages of a book; and including its reference data such as front or back of the cover book data and reference index. Also disclosed is the computerized system for dynamically indexing content at the time of authoring or editing, comprising an authoring or editing tool associated with an indexer and sorter; a lexicon or vocabulary, a spellchecker, grammar-checker or a context builder memory; storage for the content and the related index, and a computer network such as internet, with storage for the content and search engine manager or master or metadata. The system may further comprise a speech-to-text translator or an OCR or a scanner is associated with the authoring or editing tool.

The invention described above should not be contemplated in restrictive manner as many alterations and modifications are possible within the scope and limit of the appended claims.

What is claimed is:

1. A computer implemented method, said method comprising:
dynamically building an index of a web content at the time of generating said content in relation to Internet search engine corpus data, wherein said index relating an Internet search engine corpus data to said content;
updating said index in an Internet search engine master index.

2. The method of claim 1, wherein said Internet search engine corpus data comprises a term corpus data and said index comprises a term index.

3. The method of claim 1, wherein said Internet search engine corpus data comprises a semantic corpus data and said index comprises a semantic index.

4. The method of claim 1, further comprising,
spellchecking or grammar checking a term, phrase or sentence in said content in relation to a spellchecker or grammar checker corpus data.

5. The method of claim 4, further comprising,
synchronizing said spellchecker or grammar checker corpus data with an Internet search engine corpus data.

6. The method of claim 1, further comprising,
indexing a content data not found in said Internet search engine corpus data, adding said data in said master index.

7. The method of claim 1, further comprising,
said generating a web content being online or offline.

8. The method of claim 1, further comprising,
said building of index being on enabling an Application Program Interface (API).

9. The method of claim 1, further comprising,
said building an index comprises dynamically parsing, indexing, sorting and building an inverted index relating said Internet search engine corpus data to said content; said building being in background on typing a term, on line change, on content completion or on computing resources being available.

10. The method of claim 1, further comprising,
publishing or hosting said index on an Internet server, wherein said server being a host Internet server of said content or an Internet search engine server or a different server.

11. The method of claim 10, further comprising,
publishing said index in-a centralized index database of an Internet search engine.

12. The method of claim 1, further comprising,
using said index as a chunk, cache or an auxiliary index for an Internet search engine master index.

13. The method of claim 1, further comprising,
computing a rank for said content.

14. The method of claim 1, wherein said Internet search engine corpus data comprises: context, controlled vocabulary, taxonomy, thesauri, ontology, concept, strata, model, or meta-model.

15. The method of claim 14, further comprising,
prompting a selectable option, said option further comprising an option to lock a selection for a session.

16. The method of claim 1, further comprising,
recording sequence of a term, phrase or sentence in said content.

17. The method of claim 16, further comprising,
reconstructing text of said content.

18. The method of claim 1, wherein said content comprises dynamic content or multimedia content.

19. A computer-readable storage medium encoded with an executable computer program, said computer program comprising program code for:
dynamically building an index of a web content at the time of generating said content in relation to Internet search engine corpus data, wherein said index relating an Internet search engine corpus data to said content;
updating said index in an Internet search engine master index;
producing a search result responsive to search query.

20. A system, said system comprising: a computer readable storage medium comprising:
a processor configured for dynamically building an index of a web content at the time of generating said content in relation to Internet search engine corpus data, wherein said index relating an Internet search engine corpus data to said content; the processor further configured for updating said index in an Internet search engine master index;
an Internet search engine configured for producing a search result responsive to search query.
